(19) United States
(12) Patent Application Publication
(10) Pub. No.: US 2010/0123260 A1
(43) Pub. Date: May 20, 2010

(54) STAMP WITH MASK PATTERN FOR DISCRETE LENS REPLICATION

(76) Inventors: Jacques Duparre, Jena (DE); Steve Oliver, San Jose, CA (US); Shashikant Hegde, Boise, ID (US)

Correspondence Address: DICKSTEIN SHAPIRO LLP, 1825 EYE STREET NW, Washington, DC, 20006-5403, US

(21) Appl. No.: 12/274,021

(22) Filed: Nov. 19, 2008

(51) Int. Cl. B29D 11/00; B28B 17/00

(52) U.S. Cl. 264/1.38; 264/1.36; 425/174.4; 264/220; 156/245

(57) ABSTRACT

A method and stamp for forming lenses on a wafer. The stamp includes a mask arranged on a substrate and aligned with a plurality of lens-shaped cavities. The lens-shaped cavities are used to imprint a plurality of lenses into a curable material. The lenses are cured through the mask using radiation. The lenses are separated from the stamp and the uncured material is removed.

### FIELD OF THE INVENTION

The embodiments described herein relate to optical lenses and methods of making the same.

### BACKGROUND OF THE INVENTION

Microelectronic imagers are used in a multitude of electronic devices. As microelectronic imagers have decreased in size and improvements have been made with respect to image quality and resolution, they have saturated commonplace devices including mobile telephones and personal digital assistants (PDAs) in addition to their traditional uses in digital cameras.

Microelectronic imagers include image sensors that typically use charged coupled device (CCD) systems and complementary metal-oxide semiconductor (CMOS) systems, as well as other systems. CCD image sensors have been widely used in digital cameras and other applications. CMOS image sensors are quickly becoming very popular because they have low production costs, high yields, and small sizes.

As shown in FIG. 1, microelectronic imager modules 150 are often fabricated at a wafer level. The imager module 150 includes an imager die 108, which includes an imager array 106 and associated circuits (not shown). The imager array 106 may be a CCD or CMOS imager array, or any other type of solid state imager array. The imager module 150 may also includes a lens structure 112, which includes a spacer 109 and at least one lens element 111 arranged on a lens carrier 110. The spacer 109 maintains the lens element 111 at a proper distance from the imager array 106, such that light striking a convex side of the lens element 111 is directed to the imager array 106. The spacer 109 may be bonded to the imager die 108 by a bonding material 104 such as epoxy. Typically, the lens element 111 comprises an optically transmissive glass or plastic material configured to focus light radiation onto the imager array 106. In addition, the lens structure 112 can include multiple lenses, or may be combined with another optically transmissive element, such as a package lid. The fabrication of one such imager module and associated lens support structure is discussed in co-owned U.S. patent application Ser. No. 11/605,131, filed on Nov. 28, 2006 and U.S. patent application Ser. No. 12/073,998, filed on Mar. 12, 2008.

In practice, imager modules 150 are fabricated in mass rather than individually. As shown in a top-down view in FIG. 2A and a cross-sectional view in FIG. 2B, multiple imager dies 108a-108d, each die including a respective imager array 106a-106d, are fabricated on an imager wafer 210. As shown in FIGS. 3A and 3B, multiple lens elements 111a-111d, corresponding in number and location to the imager arrays 106a-106d on the imager wafer 210, may be fabricated on a lens wafer 220 using a replication process such as ultraviolet embossing is used to duplicate the surface topology of a master mold structure onto a thin film of an ultraviolet-curable epoxy resin applied to the lens wafer 220. As shown in FIG. 4A, the imager wafer 210 and lens wafer 220 are then assembled with the lens elements 111a-111d being optically aligned with the imager dies 108a-108d to form a plurality of imager modules 150a, 150b (other imager modules are formed, but not shown in FIG. 4A). As shown in FIG. 4B, the imager modules 150a, 150b may then be separated by dicing into individual imager modules 150a, 150b.

The process of forming multiple lens elements 111 detailed above, however, suffers from several problems. First, it is difficult to maintain thickness uniformity of the lens elements 111 because bonding is done polymer-to-glass. The cured polymer that comprises lens elements 111a-111d is co-extensive with the edges of the lens wafer and so any stacking elements must be bonded to the polymer. A uniform thickness among the lens elements 111 would lower adhesive bond line thickness and make the adhesion more reliable. Second, chipping or delamination of the polymer can occur during a dicing stage of production, which can lead to decreased image quality.

Other known methods of forming multiple lens elements 111, such as using a jet dispense process suffer from problems as well. First, a jet dispense process is comparably low-throughput because lenses must be formed individually. Second, jet dispense processes commonly produce residual polymer volume (e.g., sputter) outside the lens area, which can cause problems with formation of other lenses on the lens wafer. Third, controlling polymer dispense volume is much more difficult and must be precisely maintained for each lens. Fourth, lenses produced by jet dispense processes can have voiding problems as a result of trapped air bubbles. Last, accuracy of individual lens alignment on the lens wafer varies directly with the accuracy of the dispense process. Accordingly, there is a need for a method of fabricating lens elements that yields discrete lens wafers which mitigates against such drawbacks.

### BRIEF DESCRIPTION OF THE DRAWINGS

FIG. 1 illustrates an imager module.

FIGS. 2A-2B illustrate an imager wafer assembly process.

FIGS. 3A-3B illustrate a lens wafer assembly process.

FIGS. 4A and 4B illustrate an imager module assembly process.

FIGS. 5A-5B illustrate top and cross-sectional views, respectively, of steps of a method of making a stamp according to an embodiment described herein.

FIGS. 6A-6D illustrate steps in a method of making a stamp, according to an embodiment described herein.

FIGS. 7A and 7B illustrate steps in a method of making lens elements, according to an embodiment described herein.

FIGS. 8A and 8B illustrate steps in a method of making lens elements, according to an embodiment described herein.

FIGS. 9A and 9B illustrate top and cross-sectional views, respectively, of assembled imager modules constructed in accordance with an embodiment described herein.

FIG. 10 illustrates a lens stack structure containing lenses constructed in accordance with an embodiment described herein.

FIG. 11 illustrates a block diagram of a CMOS imaging device constructed in accordance with an embodiment described herein.

FIG. 12 depicts a system constructed in accordance with an embodiment described herein.

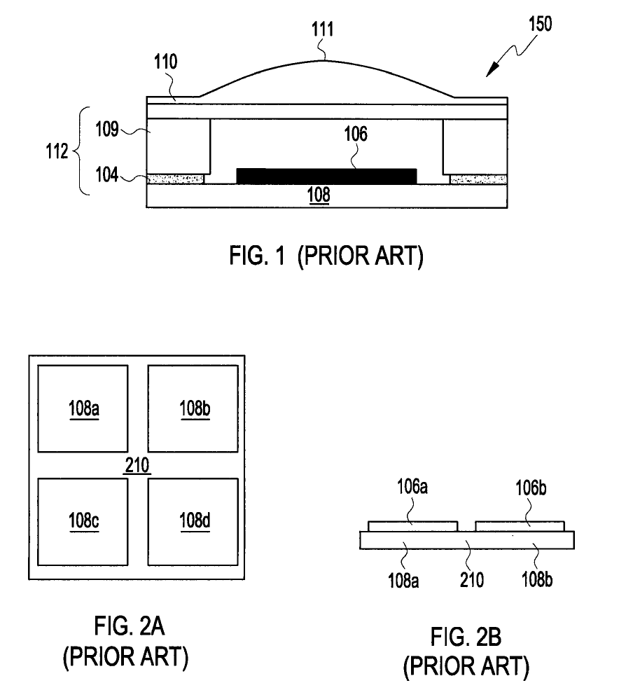

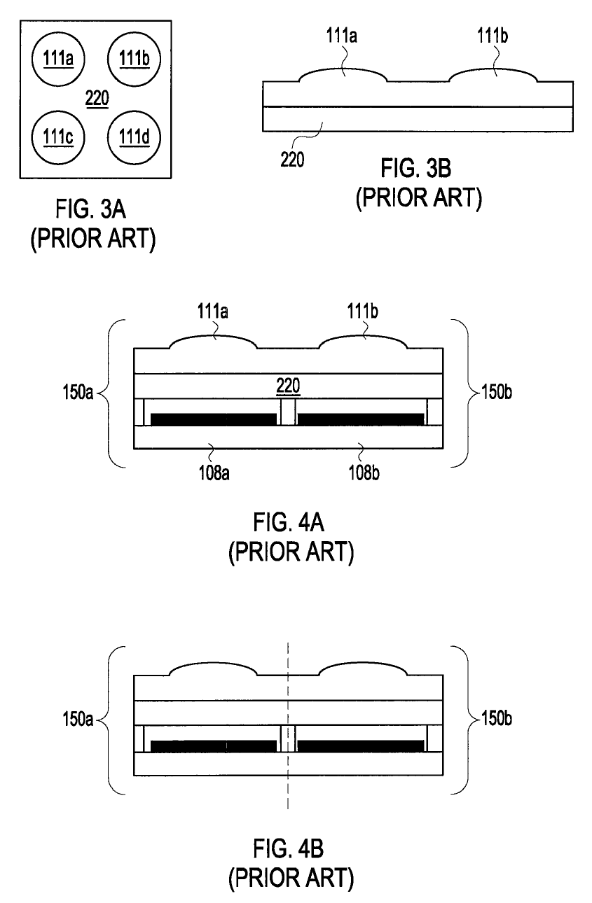

### DETAILED DESCRIPTION OF THE INVENTION

In the following description, reference is made to the accompanying drawings which form a part hereof, and in which are shown by way of illustrations specific embodiments that may be practiced. It should be understood that like reference numerals represent like elements throughout the drawings. These example embodiments are described in sufficient detail to enable those skilled in the art to practice them. It is to be understood that other embodiments may be utilized, and that structural, material and electrical changes may be made, only some of which are discussed in detail below.

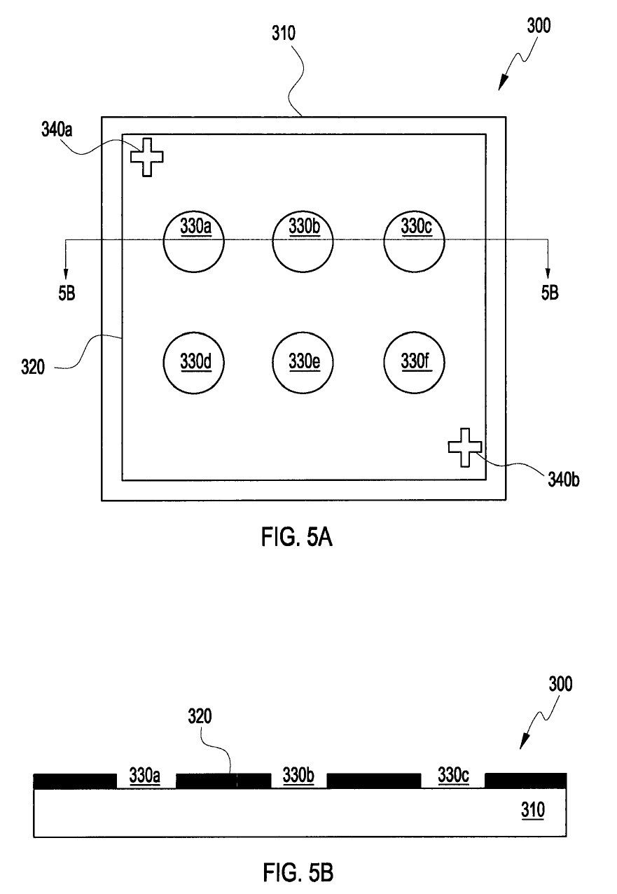

Embodiments described herein relate to a method of making a stamp having a mask pattern and methods of making discrete lenses on a wafer by using an ultraviolet replication process and the stamp. A method of forming a stamp is now described. Referring to FIGS. 5A and 5B, to form stamp 300, a mask 320 is formed on a glass substrate 310 and patterned to form a plurality of aperture openings 330a-330f. Optional alignment marks 340a, 340b can also be formed on the mask 320, depending on the alignment method chosen. The aperture openings 330a-330f, although illustrated as circular in FIG. 5A, may be rectangular or other shapes as necessary to correspond to a desired lens shape.

In one embodiment, the glass substrate 310 may comprise a float glass. One example of a float glass that may be used is a boro-float glass with a coefficient of thermal expansion between 2 and 5, such as Borofloat® 33 from Schott North America, Inc. The mask 320 can be deposited on the surface of the glass substrate 110 by any suitable method. The mask 320 can be formed of a metal, such as black chromium, or another appropriate light absorbing material, such as dark silicon or black matrix polymer, such as PSK™ 2000, manufactured by Brewer Science Specialty Materials, or JSR 812, manufactured by JSR Corporation. The aperture openings 330a-330f can be formed by photo patterning the mask 320 so that deposition of the light absorbing material does not occur on certain portions of the glass substrate 310, or by removing light absorbing material from mask 320 using other suitable methods. The optional alignment marks 340a, 340b can be formed by the same methods used to form aperture openings 330a-330f.

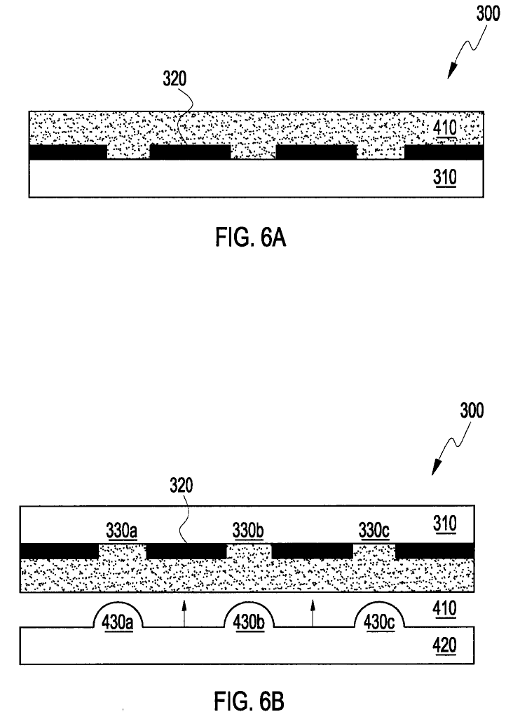

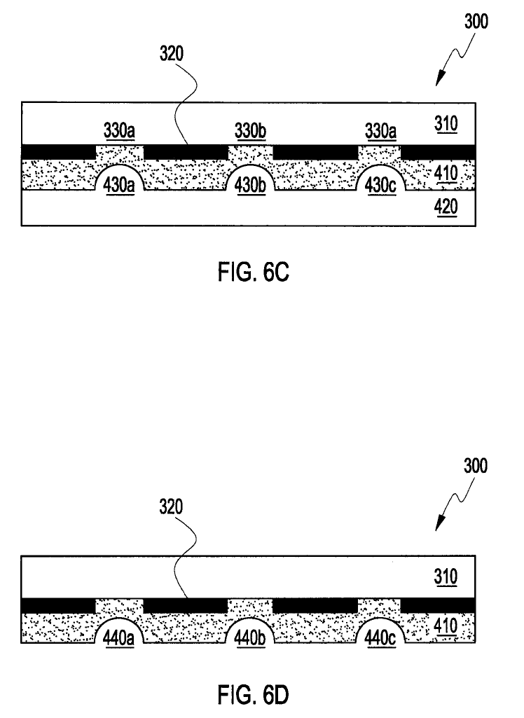

Referring now to FIG. 6A, transparent material 410 is formed on the masked glass substrate 310 over the mask 320. The transparent material 410 may be optionally bonded to the glass substrate by an adhesive agent, such as Hexamethyldisilazane (HMDS). The transparent material 410 can be any suitable material, such as a polymer, and need not have a high transparency ratio. In one embodiment, the transparent material 410 may be a material that is dissolvable in a weak solvent, for example, polyvinyl alcohol (PVA). In another embodiment, the transparent material 410 can be polydimethylsiloxane (PDMS).

As shown in FIG. 6B, the stamp 300 is reoriented and lens features 430a, 430b, 430c of a lens master wafer 420 are aligned to the aperture openings 330a, 330b, and 330c of the mask 320 (FIG. 5A). Lens master wafer 420 can be aligned to aperture openings 330a, 330b, and 330c using the optional alignment marks 340a, 340b, or, other suitable methods of alignment such as laser guiding can be used. As shown in FIGS. 6C and 6D, the lens features 430a, 430b, 430c are pressed into the transparent material 410 to create lens cavities 440a, 440b and 440c. Next, the lens master wafer 420 is removed and the transparent material 410 is cured. In another embodiment, the transparent material 410 may be a material that requires heating to soften it before lens master 420 can be pressed into it to create lens cavities 440a, 440b and 440c.

While the embodiment described in FIGS. 5A-6D show cross-sectional views of a stamp 300 having six lens cavities (only three lens cavities 440a-440c are shown), it should be understood that, in practice, a stamp 300 may have tens, hundreds, or even thousands of lens cavities. It should also be understood that while the embodiments described in FIGS. 5A-6B detail the production of a single stamp 300, in practice, many such stamps 300 could be produced at the same time.

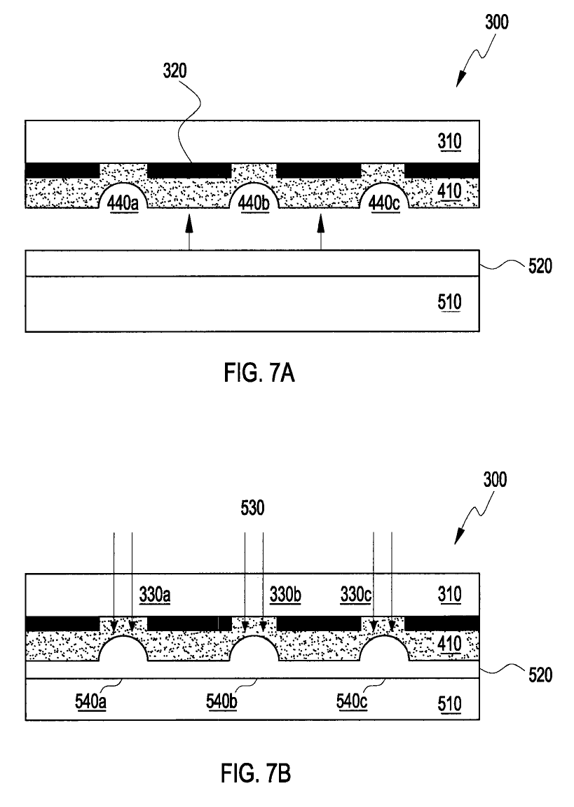

A method of making a plurality of lens elements using the stamp 300 (FIG. 6D) is now described. As shown in FIG. 7A, curable material 520 is applied to a lens wafer 510 and the lens wafer 510 is positioned under stamp 300 and optionally aligned with alignment marks 340a, 340b. In one embodiment, the curable material 520 may be a low dispersion (Abbe number>50) ultraviolet-curable resist or other hybrid polymer that requires curing, and may be optionally bonded to the wafer lens 510 by an adhesive agent, such as Hexamethyldisilazane (HMDS). One example of such an ultraviolet-curable hybrid polymer is Ormocomp® from Micro Resist Technology.

As shown in FIG. 7B, stamp 300 is used to imprint curable material 520 into lenses 540a, 540b, 540c (as discussed above, stamp 300 has six lens cavities, thus, six lenses are formed but not all are shown). An ultraviolet source directs ultraviolet radiation 530 towards the glass substrate 310 of stamp 300. The aperture openings 330a, 330b, and 330c in mask 320 allow the ultraviolet radiation 530 to cure the lenses 540a, 540b, and 540c, while leaving a portion of uncured material between each lens 540a-540c.

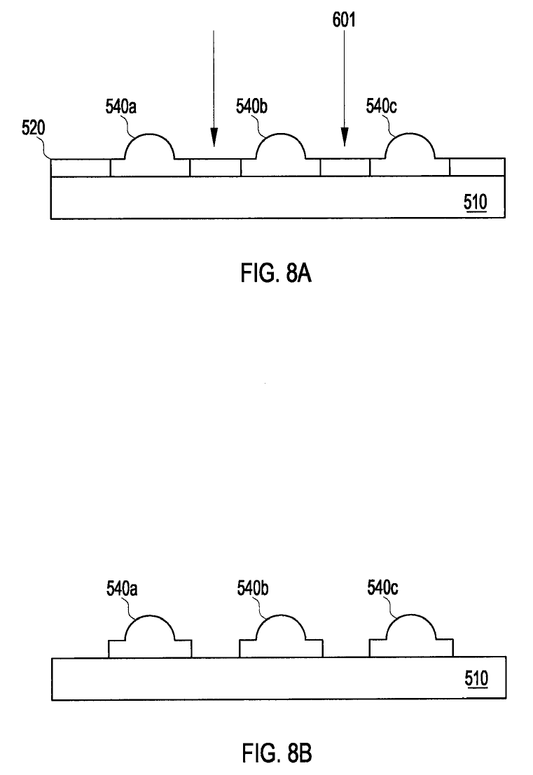

Referring now to FIG. 8A, the lens wafer 510 is separated from the stamp 300. In one embodiment, the stamp 300 and lens wafer 510 can be placed in a weak solvent bath to dissolve the transparent polymer material 410, but not the cured lenses 540a, 540b, and 540c or the uncured material 520 between them. In this embodiment, the glass substrate 310 and mask 320 used in the stamp 300 can be reused multiple times by forming a new layer of transparent material 410 on the mask 320 and imprinting lens cavities 440a, 440b and 440c with a lens master 420. In another embodiment, transparent material 410 is not dissolved and stamp 300 can be mechanically separated from the lens wafer 510.

In one embodiment, the uncured material 520 located between the lenses 540a, 540b, and 540c is removed by a developer chemical 601. One example of such a developer chemical is isopropyl alcohol. As shown in FIG. 8B, the discrete lenses 540a-540c remain on the lens wafer 510.

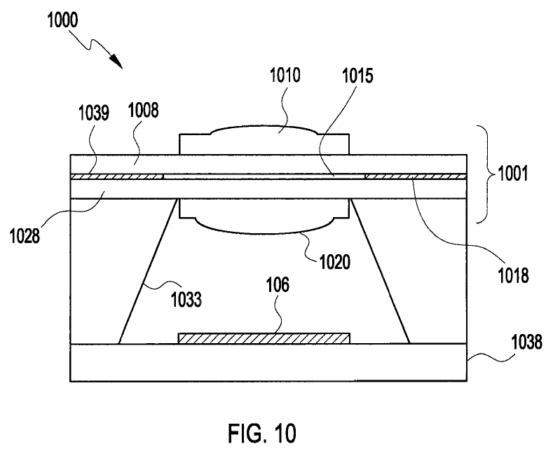

This particular method has several advantages over previous ultraviolet replication technology, due to the absence of polymer film present across the glass wafer: Bonding is done glass-to-glass (an exemplary illustration is shown in FIG. 10), improving thickness uniformity and the dicing process for lens singulation is much easier since it can be done through plain glass.

The method proposed herein also has several key advantages over other known methods as well, such as a jet dispense process. First, the proposed process is high-throughput and multiple lenses are made in a single ultraviolet imprint. Second, the proposed process offers better control of residual polymer volume which resides outside the lens area because residual polymer (e.g. uncured material 520 shown on FIG. 8A) is removable. The residual polymer can be controlled by changing aperture size or stamp thickness. In a dispense approach the control of polymer volume is much more difficult and squeeze-out needs to be carefully maintained for each lens. Third, the present process does not have voiding problems due to trapped air bubbles. Last, lateral alignment accuracy is maintained very well. In a dispense approach lens alignment accuracy will depend on dispense alignment accuracy.

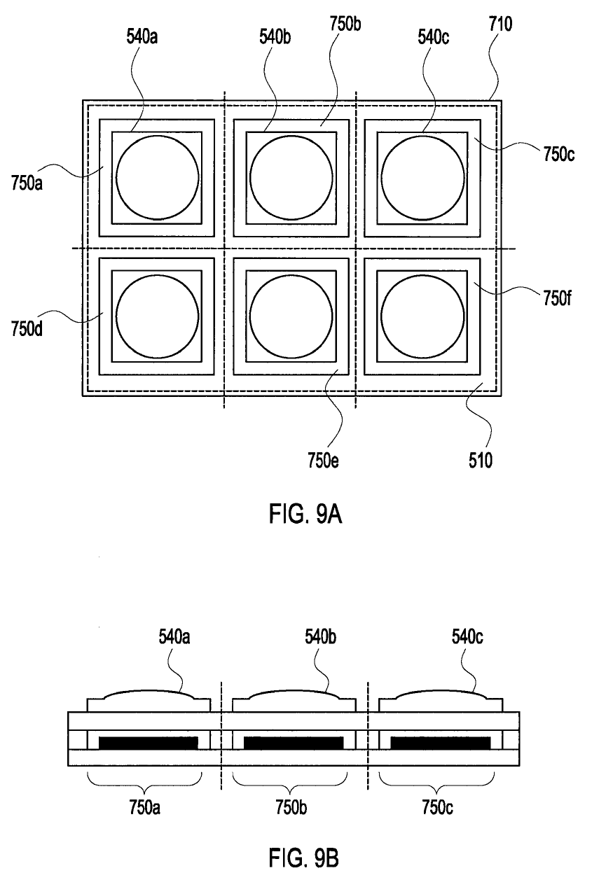

FIGS. 9A and 9B are top down and cross-sectional views, respectively, of assembled imager modules, constructed in accordance with an embodiment described herein. As shown in FIGS. 9A and 9B, the lens wafer 510 may be optically aligned with imager dies on an imager wafer 710 to form a plurality of imager modules 750a-750f, which may then be separated into individual imager modules. Alternatively, the lens wafer 510 may be separated prior to being joined with imager dies.

FIG. 10 shows a cross-sectional view of an embodiment of an exemplary imaging module 1000 with a lens stack 1001 comprising lenses 1010 and 1020 produced by the methods described herein. Outer positive lens 1010 is mounted on lens wafer 1008 and separated from inner positive lens 1020 mounted on lens wafer 1028 by a transparent substrate 1015 and spacers 1039. In another embodiment, transparent substrate 1015 can be a photographic filter, such as an ultraviolet, polarizing, or fluorescent filter. A spacer 1033 separates the lens stack 1001 from an imager wafer 1038 having an image sensor 106 in the image plane. Spacer 1033, which can be formed of the same material as imager wafer 1038, can be bonded directly to both imager wafer 1038 and lens wafer 1028 with a glass-to-glass bond.

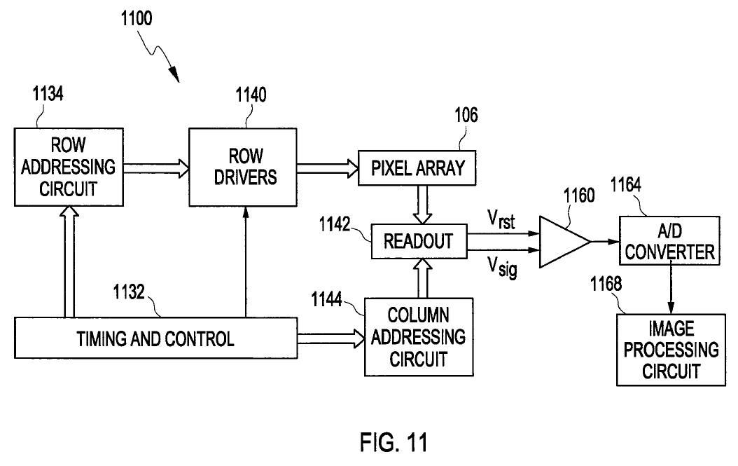

FIG. 11 shows a block diagram of an imaging device 1100, (e.g. a CMOS imager), that may be used in conjunction with a lens 540 according to embodiments described herein. A timing and control circuit 1132 provides timing and control signals for enabling the reading out of signals from pixels of the pixel array 106 in a manner commonly known to those skilled in the art. The pixel array 106 has dimensions of M rows by N columns of pixels, with the size of the pixel array 106 depending on a particular application.

Signals from the imaging device 1100 are typically read out a row at a time using a column parallel readout architecture. The timing and control circuit 1032 selects a particular row of pixels in the pixel array 106 by controlling the operation of a row addressing circuit 1034 and row drivers 1140. Signals stored in the selected row of pixels are provided to a readout circuit 1042. The signals are read from each of the columns of the array sequentially or in parallel using a column addressing circuit 1144. The pixel signals, which include a pixel reset signal Vrst and image pixel signal Vsig, are provided as outputs of the readout circuit 1042, and are typically subtracted in a differential amplifier 1160 and the result digitized by an analog to digital converter 1164 to provide a digital pixel signal. The digital pixel signals represent an image captured by an exemplary pixel array 106 and are processed in an image processing circuit 1168 to provide an output image.

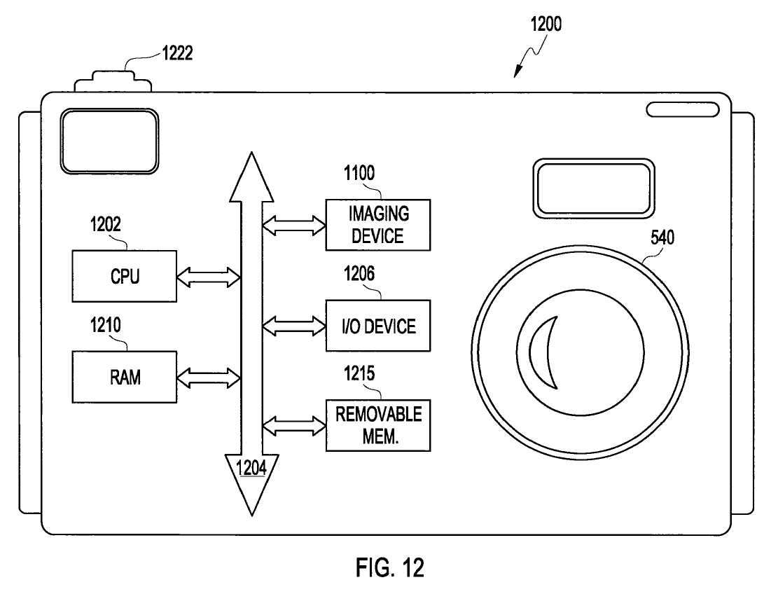

FIG. 12 shows a system 1200 that includes an imaging device 1200 and a lens 540 constructed and operated in accordance with the various embodiments described above. The system 1200 is a system having digital circuits that include imaging device 1100. Without being limiting, such a system could include a computer system, camera system, scanner, machine vision, vehicle navigation, video telephone, surveillance system, auto focus system, star tracker system, motion detection system, image stabilization system, or other image acquisition system.

System 1200, e.g., a digital still or video camera system, generally comprises a central processing unit (CPU) 1202, such as a control circuit or microprocessor for conducting camera functions that communicates with one or more input/output (I/O) devices 1206 over a bus 1204. Imaging device 1000 also communicates with the CPU 1202 over the bus 1104. The processor system 1200 also includes random access memory (RAM) 1210, and can include removable memory 1215, such as flash memory, which also communicates with the CPU 1202 over the bus 1204. The imaging device 1100 may be combined with the CPU processor with or without memory storage on a single integrated circuit or on a different chip than the CPU processor. In a camera system, a lens 540 according to various embodiments described herein may be used to focus image light onto the pixel array 106 of the imaging device 1100 and an image is captured when a shutter release button 1222 is pressed.

While embodiments have been described in detail in connection with the embodiments known at the time, it should be readily understood that the claimed invention is not limited to the disclosed embodiments. Rather, the embodiments can be modified to incorporate any number of variations, alterations, substitutions or equivalent arrangements not heretofore described. For example, while some embodiments are described in connection with a CMOS pixel imaging device, they can be practiced with any other type of imaging device (e.g., CCD, etc.) employing a pixel array or a camera using film instead of a pixel array.

Although certain advantages have been described above, those skilled in the art will recognize that there may be many others. For example, the steps in the methods described herein may be performed in different orders, or may include some variations, such as alternative materials having similar functions. Furthermore, while the substrate and stamps are described above in various embodiments as being transparent, alternate embodiments are possible in which the substrate and stamps are opaque and an alternate form of radiation to ultraviolet is used to cure the lenses. Accordingly, the claimed invention is not limited by the embodiments described herein but is only limited by the scope of the appended claims.

1. A method for creating a plurality of lenses, the method comprising:
forming ultraviolet-curable material on a wafer;
imprinting a plurality of lenses into the ultraviolet-curable material using a stamp, the stamp comprising:
a substrate,
a mask comprising a plurality of apertures, and
a mold material comprising a plurality of lens-shaped cavities, each lens-shaped cavity being aligned with a respective aperture; and
curing the lenses using a single ultraviolet imprint such that the mask prevents curing of at least a portion of the ultraviolet-curable material between the lenses.

2. The method of claim 1, further comprising removing the uncured curable material between the lenses.

3. The method of claim 1, wherein the substrate and the mold material are transparent.

4. (canceled)

5. The method of claim 1, further comprising aligning the wafer to at least one alignment mark on the stamp.

6. The method of claim 1, wherein the act of forming the curable material on the wafer comprises affixing the curable material to the wafer with an adhesive.

7. The method of claim 1, further comprising mechanically separating the stamp from the wafer after curing the lenses.

8. The method of claim 1, further comprising separating the stamp from the wafer by dissolving the mold material.

9-25. (canceled)

26. The method of claim 8, wherein dissolving the mold material comprises placing the stamp and wafer in a weak solvent bath.

27. The method of claim 2, wherein the uncured curable material is removed with a developer chemical.

28. The method of claim 27, wherein the developer chemical is isopropyl alcohol.

29. A method of forming a plurality of imagers, the method comprising:
forming a plurality of imager dies on an imager wafer;
forming ultraviolet-curable material on a lens wafer;
imprinting a plurality of lenses into the ultraviolet-curable material using a stamp, the stamp comprising:
a substrate,
a mask comprising a plurality of apertures, and
a mold material comprising a plurality of lens-shaped cavities, each lens- shaped cavity being aligned with a respective aperture;
curing the lenses using a single ultraviolet imprint such that the mask prevents curing of at least a portion of the ultraviolet-curable material between the lenses;
bonding the lens wafer to the imager wafer; and
separating the joined imager wafer and lens wafer into individual imagers.

30. The method of claim 29, further comprising removing the uncured curable material between the lenses before affixing the lens wafer over the imager wafer.

31. The method of claim 29, wherein the substrate and the mold material are transparent.

32. (canceled)

33. The method of claim 29, further comprising aligning the lens wafer to at least one alignment mark on the stamp.

34. The method of claim 29, wherein the act of forming the curable material on the lens wafer comprises affixing the curable material to the lens wafer with an adhesive.

35. The method of claim 29, further comprising mechanically separating the stamp from the lens wafer after curing the lenses.

36. The method of claim 29, further comprising separating the stamp from the lens wafer by dissolving the mold material.
